(19) United States
(12) Patent Application Publication
(10) Pub. No.: US 2002/0178112 A1
(43) Pub. Date: Nov. 28, 2002

(54) Point of sale check service

(75) Inventors: Michael Goeller, Fremont, CA (US); Candace Anthony Lilly, Half Moon Bay, CA (US)

Correspondence Address: BEYER WEAVER & THOMAS LLP, P.O. BOX 778, BERKELEY, CA, 94704-0778, US

(73) Assignee: Visa International Service Association

(21) Appl. No.: 09/810,945

(22) Filed: Mar. 15, 2001

Related U.S. Application Data
(60) Provisional application No. 60/225,566, filed on Aug. 14, 2000.
(60) Provisional application No. 60/227,712, filed on Aug. 24, 2000.

(51) Int. Cl. G06F 17/60

(52) U.S. Cl. 705/39

(57) ABSTRACT

A POS (point-of-sale) Check Service converts any paper check online and in real-time into an electronic funds transaction. The paper check is returned to the customer. A merchant enters the amount of the sale and electronically captures checking account data from the MICR line encoded on the check. The check data, identification data and sale amount are forwarded to a service organization for processing. The service has three options: Conversion Only; Verification with Conversion; and Guarantee with Conversion. Under Conversion Only the transaction is approved or declined with no account verification processing and the merchant retain the risk of loss. Under Verification with Conversion the check authorization message is routed to the participating drawee bank or to a third-party authorizing agent for verification that the check will be paid. Under Guarantee with Conversion, the check authorization request message is routed to the participating drawee bank or to a third party to guarantee the check. A check guarantor buys the check from the merchant at a discount.

This application claims priority of U.S. provisional patent application No. 60/225,566 filed Aug. 14, 2000, of provisional patent application No. 60/227,712 filed Aug. 24, 2000, and of provisional patent application No. ______ (Atty Docket No. VISAP062PX2) filed Feb. 22, 2001, which are all hereby incorporated by reference.

### FIELD OF THE INVENTION

The present invention relates generally to financial transactions. More specifically, the present invention relates to an online, real-time point-of-sale check authorization system.

### BACKGROUND OF THE INVENTION

Paper checks count for over 50% of U.S. personal consumption expenditures. The handling and processing cost of paper checks at the point of sale, as well as the costs and losses associated with checks, presents significant loss to merchants and the depository institutions who accept these checks. In 1999 alone, consumers wrote an estimated 19 billion checks at the point of sale. Check handling costs and losses for merchants are estimated at $23 billion per year and in 1999 this was an average of more then $1.00 for every check written at the point of sale. Some estimates place bank costs for processing checks at close to 20% of non-interest expense.

For banks, these check processing costs are the single largest segment of non-interest related expense, totaling more than $40 billion in cost for all checks and approximately $11 billion dollars for point-of-sale checks alone. Merchants spend about $10 billion in acceptance and deposits of paper checks. Merchants' losses from acceptance of checks, with fraud and other reasons, total more than $12 billion dollars.

In today's merchant market, check authorizations are performed by a host of third-party, non-bank competitors who authorize checks using various combinations of negative-file and credit-bureau positive information often in conjunction with neural models, to advise merchant clients of the likelihood that a check will clear the settlement process once it is posted. The third-party information system uses check and consumer account data without paying banks for that data. These third-party check authorizers have also begun pilot offerings in which the paper check is truncated at the point of sale and converted into an ACH item for settlement.

Although there are notable advances in the prior art, the available references do not provide an adequate solution to the cost and difficulty of processing paper checks. Most relevant references are U.S. Pat. Nos. 5,832,463, 5,703,344 and 5,175,682.

U.S. Pat. No. 5,832,463 discloses a system for the real-time conversion of checks issued by a participating bank or through an Automated Clearing House (ACH) transfer. This system is inapplicable for participating drawee banks. For non-participating banks, a paper check must be processed. The system is closed and only handles checks from institutions that are part of the EDS system. This system is for Conversion Only; the system does not teach or suggest the real-time verification or guarantee of checks at the point of sale.

U.S. Pat. No. 5,703,344 discloses a real-time, point-of-sale check confirmation and guarantee system that uses VisaNet for checks issued by member or non-member third-party institutions. This system does not involve check conversion and only discloses batch processing of checks. Further, this system does not disclose real-time check conversions.

U.S. Pat. No. 5,175,682 discloses a system of processing checks by verifying and converting in either batch mode or in real-time if certain predefined circumstances are present. There is no online access to demand deposit accounts nor online, real-time access for any bank. The system does not disclose the real-time guarantee of any personal checks.

U.S. Pat. No. 5,053,607 discloses a point-of-sale device only and has no details concerning a payment infrastructure. U.S. Pat. No. 5,532,464 discloses an electronic check presentment system but still involves the processing of a paper check. U.S. Pat. No. 6,006,208 discloses a system for making a payment by telephone. U.S. Pat. No. 5,484,988 discloses check clearing through an ACH transaction which is batch driven and not in real-time. Further, conversions are not performed online, in real-time against any possible bank. U.S. Pat. No. 5,963,219 discloses a system for generating electronic checks. There are no paper checks involved at all and there is no conversion of paper checks occurring.

It is desirable then for a point-of-sale check service to be able to authorize checks online and in real-time for any possible bank upon which a check is drawn.

### SUMMARY OF THE INVENTION

To achieve the foregoing, and in accordance with the purpose of the present invention, a POS (point of sale) Check Service is disclosed that converts paper checks online and in real-time into an electronic funds transaction. This service will significantly reduce paper check processing costs for member banks and merchants. Advantageously, the service accepts any paper personal check from any bank, and authorizes it online, in real-time at the point of sale. The paper check is returned to the consumer for his or her records. It is not necessary for the merchant to keep the paper check.

The service operates in real-time over a data communications network and does not need to rely upon voice communications. Also, unlike a typical ACH transaction which may take 48 hours, check authorization can occur in a matter of seconds. No PIN (personal identification number) is required to be entered, and the system can process a check from a participating bank or from a non-participating bank.

It is estimated that by routing and processing electronic check transactions, banks and merchants will eliminate billions of dollars in annual paper check handling costs. Thus, a benefit of the POS Check Service is significantly reducing paper check processing costs for banks and merchants. For acquiring banks, the POS Check Service leverages existing payment networks and infrastructure and adds a new source of revenues for all points of sale. For a merchant, the POS Check Service lowers the cost of check processing, reduces risk because paper check handling is eliminated, speeds customer checkout, provides more efficient clearing and settlement, reduces losses by providing options for check guarantee or verification, and lowers check losses by retrieving online check authorizations directly from the bank on which the check is drawn. For a participating drawee bank, the POS Check Service provides an opportunity to authorize checks, allows use of existing infrastructure to convert paper checks to electronic transactions, and greatly reduces the cost of processing checks. For the customer who writes the check, the POS Check Service provides transaction details that can be included on a monthly bank statement, enables faster checkout, returns the voided check and sales draft receipt to the customer, and also improves security because the check is returned to the customer at the time of the transaction.

### BRIEF DESCRIPTION OF THE DRAWINGS

The invention, together with further advantages thereof, may best be understood by reference to the following description taken in conjunction with the accompanying drawings in which:

FIG. 1 illustrates an embodiment of the POS Check Service authorization and clearing system.

FIG. 2 is a flow diagram describing the overall POS Check Service flow.

FIG. 3 is a flow diagram describing the setup procedures for the POS Check Service.

FIG. 4 is a more detailed illustration of a paper check.

FIG. 5 is a flow diagram describing how a request is initiated to convert a check at the point of sale.

FIGS. 6A, 6B and 6C are a flow diagram describing the authorization and clearing of a transaction.

FIG. 7 is flow diagram describing the completion of a transaction at the point of sale.

FIG. 8 illustrates an example of a transaction receipt printed at the point of sale.

FIG. 9 is a flow diagram describing the settlement of transactions.

FIG. 10 illustrates the settlement process for transactions settled via the service organization or switch.

FIG. 11 illustrates the settlement process for POS Check Service transactions via the ACH.

FIG. 12 illustrates a settlement flow for a participating drawee bank.

FIG. 13 illustrates a settlement flow for a non-participating drawee bank.

FIG. 14 illustrates an alternative settlement flow for a non-participating drawee bank.

FIG. 15 illustrates an example of an authorization and settlement flow in which the acquirer and the drawee bank are the same.

FIG. 16 is an example of an authorization flow in which the acquiring bank is not the same as the drawee bank.

FIG. 17 is an example of an authorization flow in which the customer's check is to be drawn on a bank which does not participate in the POS Check Service.

FIG. 18 is an example of an activity report for a participating drawee bank.

FIG. 19 illustrates a telecommunications network suitable for implementing an embodiment of the present invention.

FIG. 20 illustrates systems housed within an interchange center to provide online and offline transaction processing.

FIG. 21 illustrates another view of the components of the telecommunications network.

FIG. 22 illustrates in more detail a suitable hardware embodiment for the POS Check Service.

FIGS. 23A and 23B illustrate a computer system suitable for implementing embodiments of the present invention.

### DETAILED DESCRIPTION OF THE INVENTION

A merchant first initiates a POS Check Service transaction by entering the amount of the sale and by passing the check through a reader to electronically capture checking account data from the magnetic ink character recognition (MICR) line encoded on the customer's check. The merchant can optionally key enter customer identification information, such as a driver's license number, at the point of sale. The check data, identification data and sale amount are combined with other data elements and forwarded to a service organization for processing. As another option, the merchant decides whether to send all transactions through the Service or only participating transactions through the Service. For a merchant opting to send only participating transactions through the Service, the service organization may distribute routing tables which the merchant can use to identify participating transactions. These transactions would be cleared and settled through the service organization. In this instance, these transactions would never be routed through the ACH.

The service begins by swiping the check through a check reader at the point of sale. The transaction is formatted into a check authorization message and one of three service options is selected automatically or manually: Conversion Only; Verification with Conversion; or Guarantee with Conversion. Under Conversion Only the transaction is approved or declined without the requirement of account verification processing, and the merchant retains the risk of loss. Under Verification with Conversion, the check authorization message is routed to the participating drawee bank or to a third-party authorizing agent for verification of the probability that the check will be paid. The authorizing agent can accept or decline based on access to the demand deposit account (DDA) and/or the third-party risk management database. Again, the merchant retains the risk of loss.

Under Guarantee with Conversion, the check authorization request message is routed to the participating drawee bank or to a third-party authorizing agent to guarantee the check. A check guarantor effectively buys the check from the merchant at a discount, eliminating the risk of loss to the merchant. The guarantor makes an accept or decline decision, based on access to the DDA account and/or to a third-party risk management database. The guarantor bears the risk of loss.

### High Level System Description

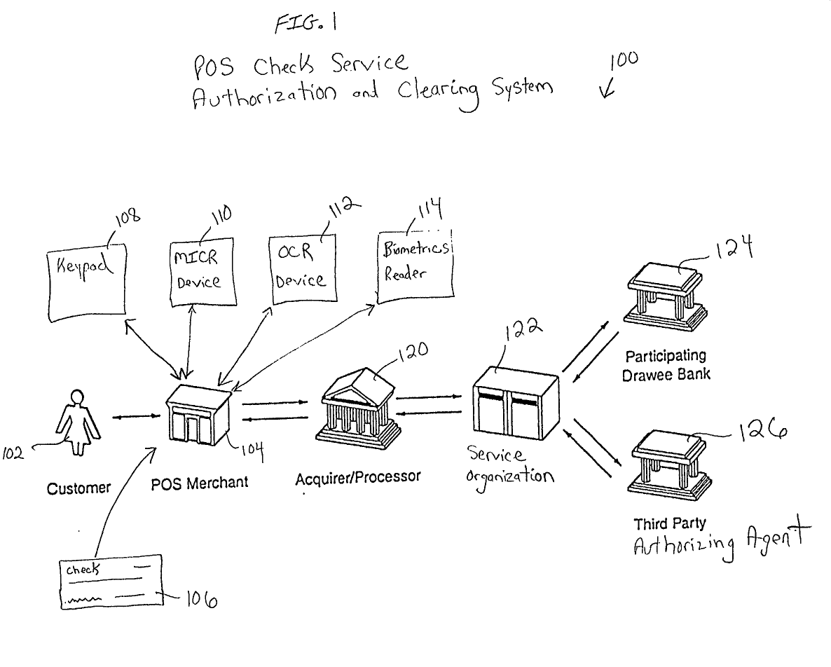

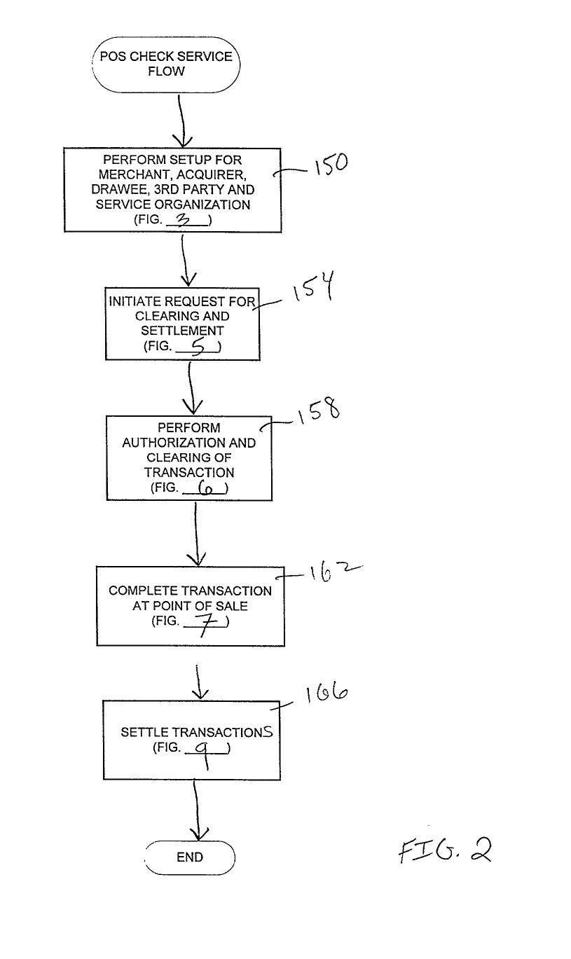

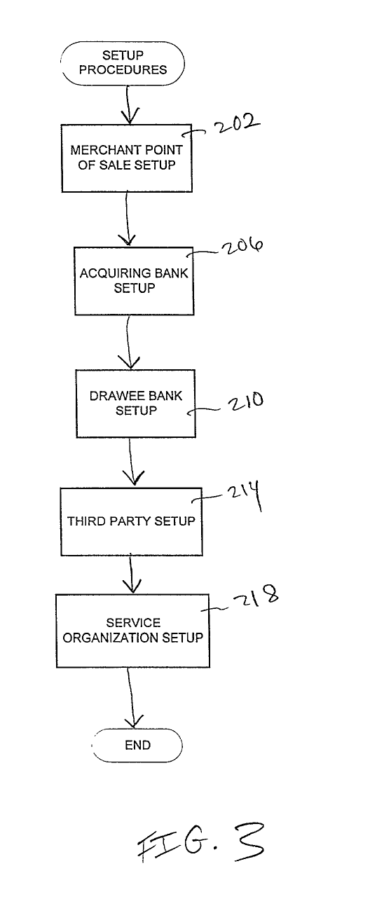

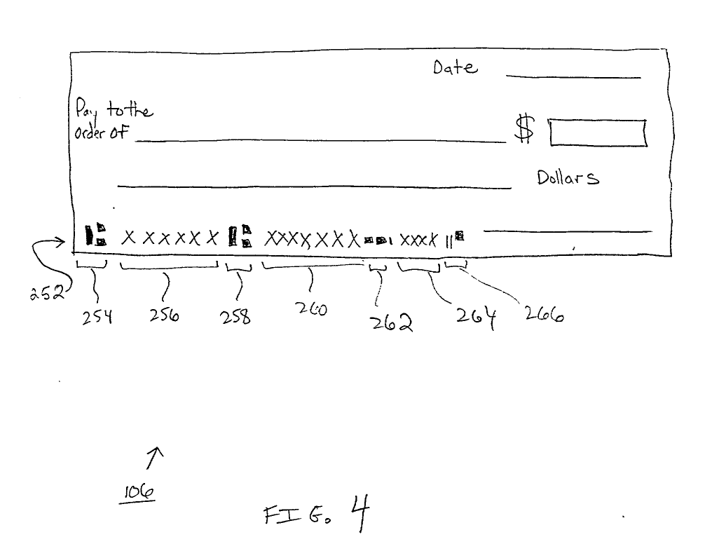

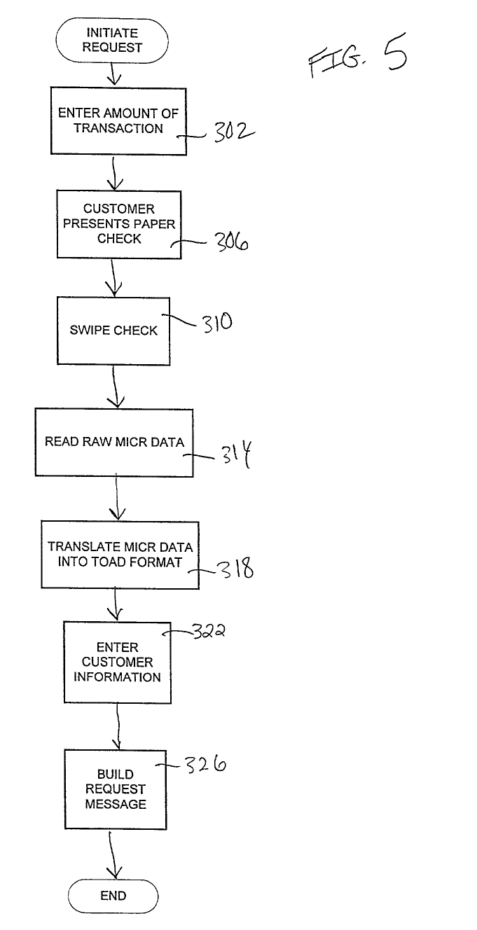

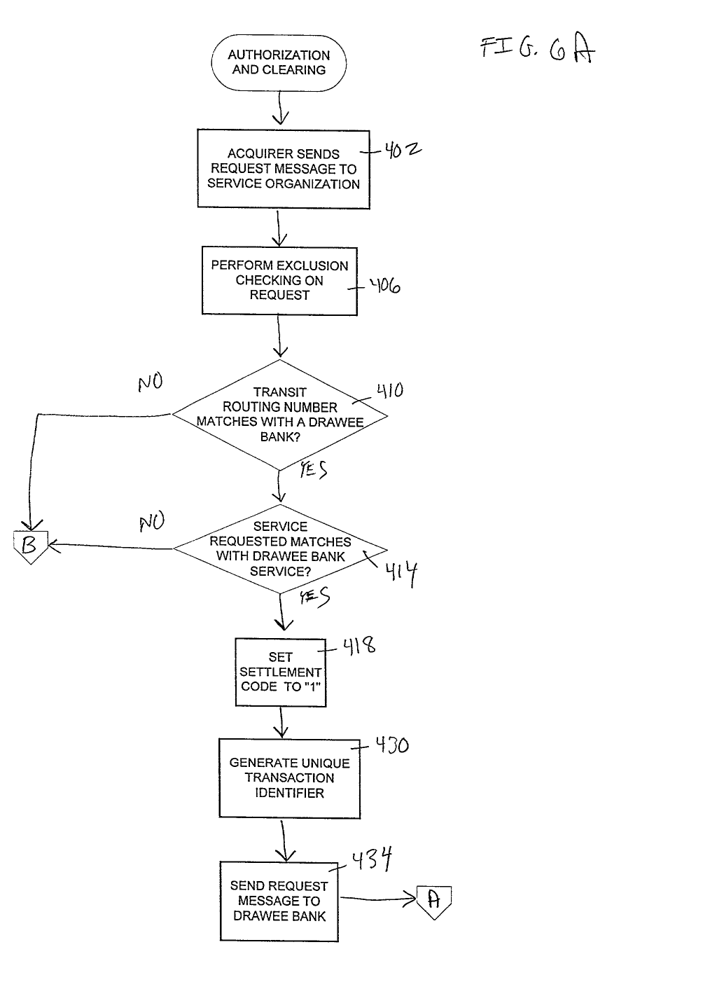

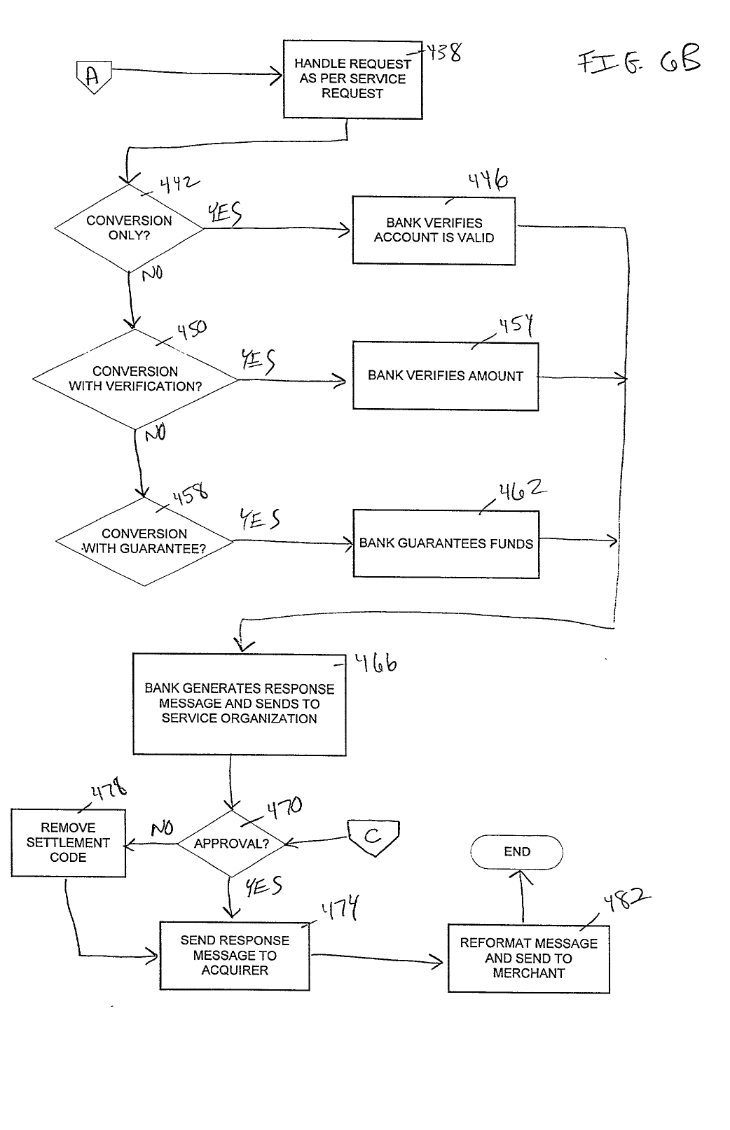

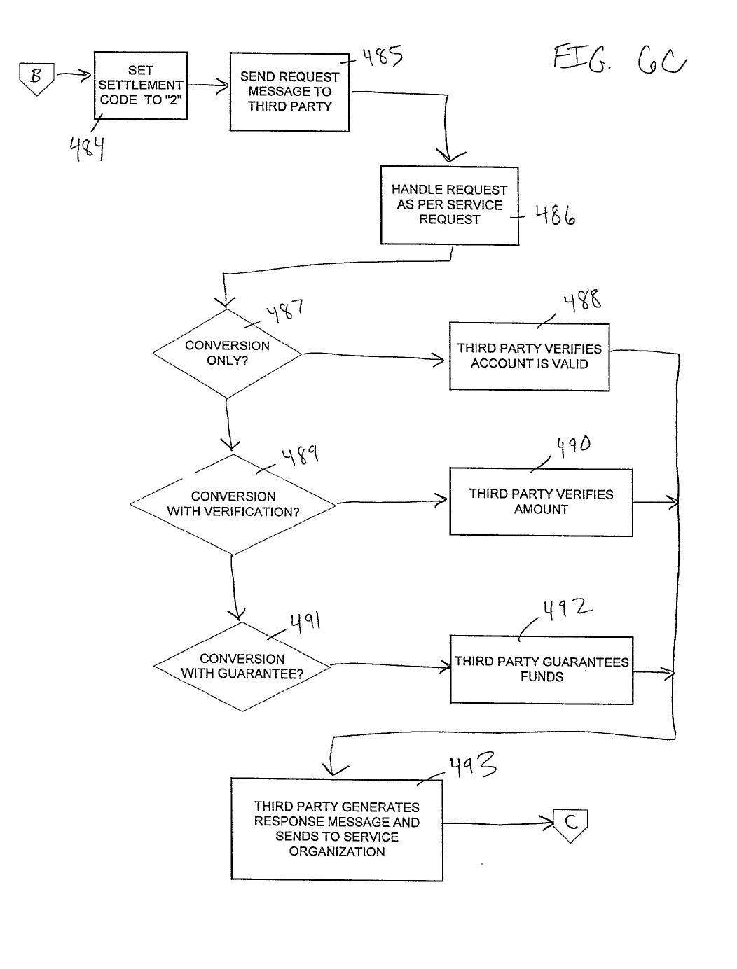

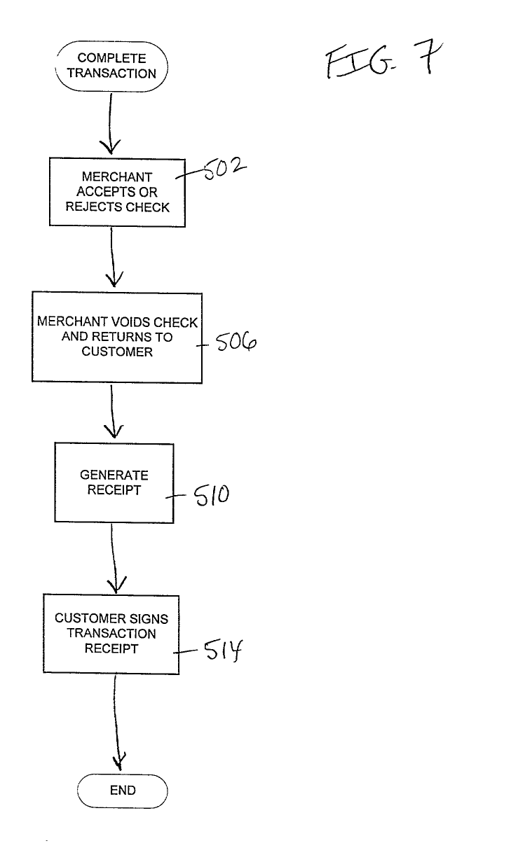

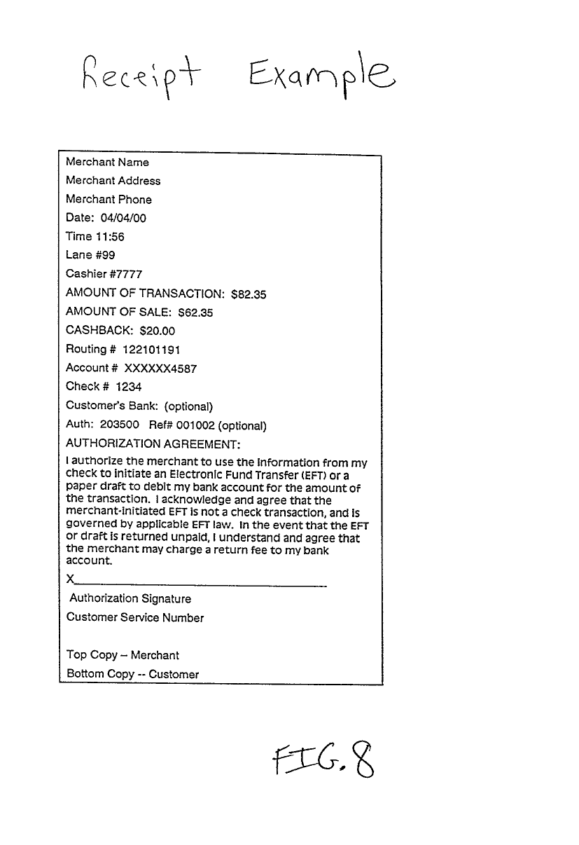

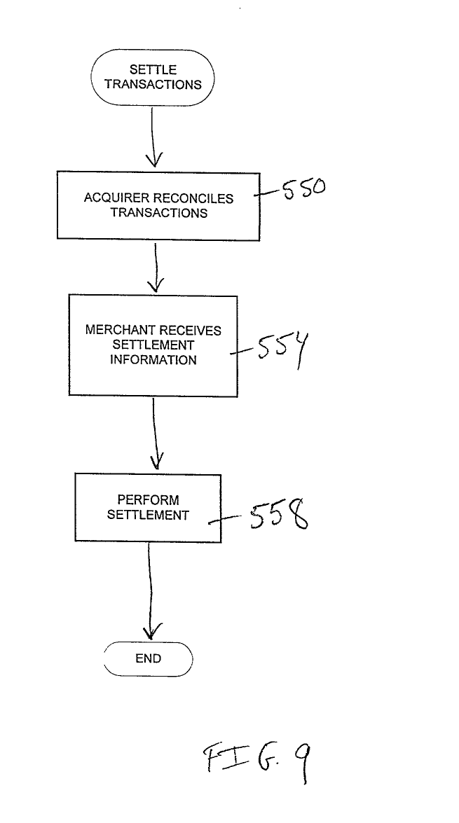

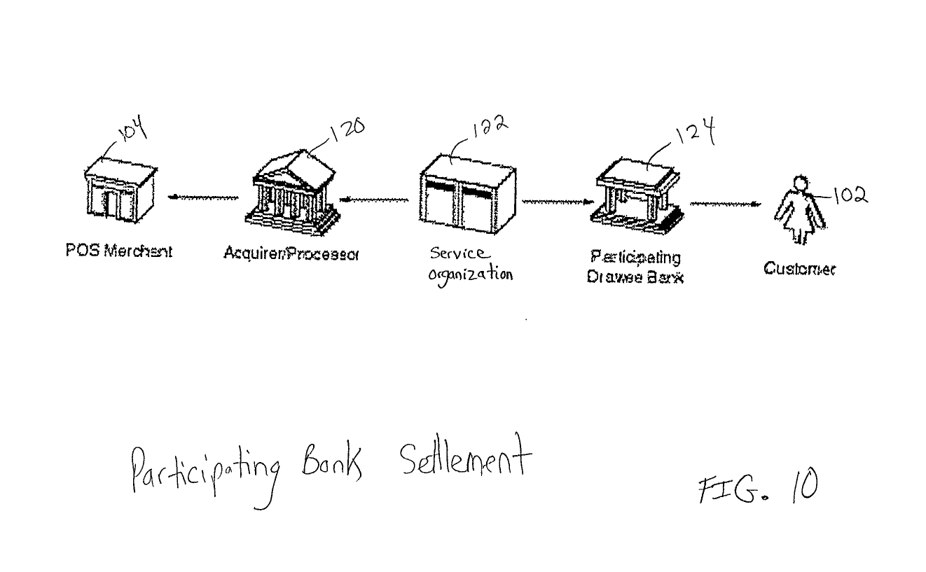

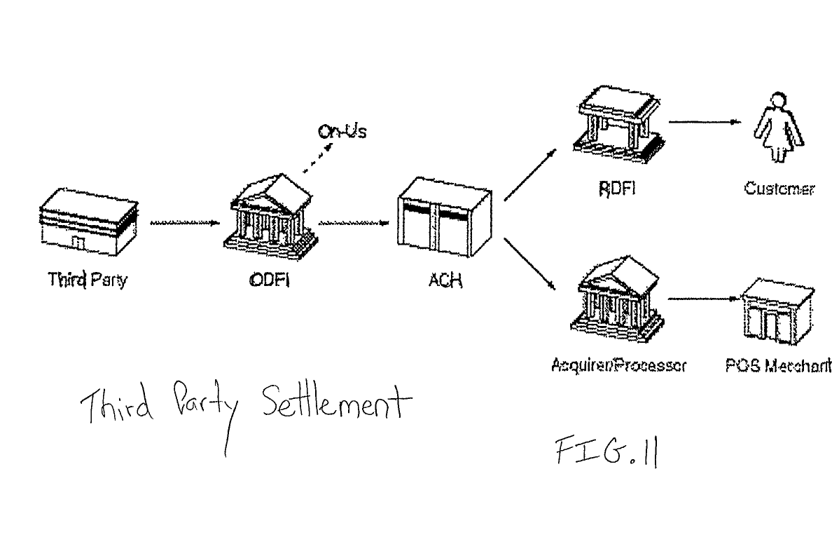

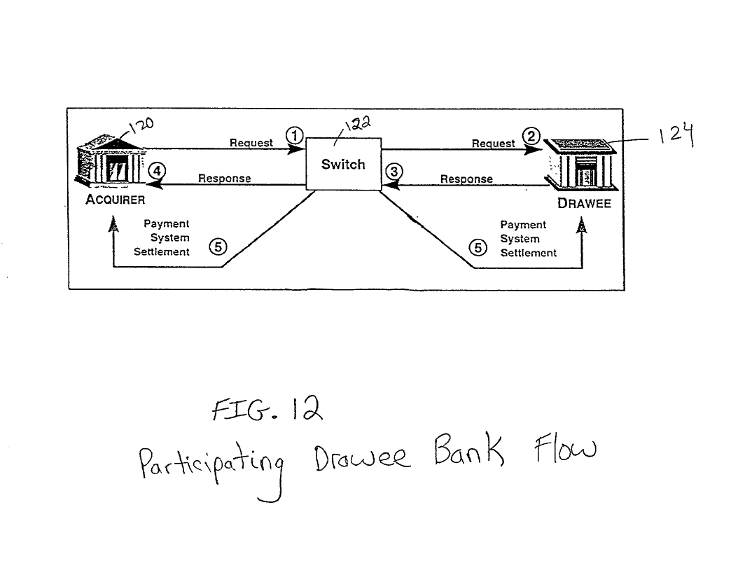

FIG. 1 illustrates POS Check Service authorization and clearing system 100. System 100 is used to convert a paper check at the point of sale into an electronic transaction and to authorize and clear the check. Customer 102 wishes to perform a transaction with a merchant 104 using a paper check 106. Merchant 104 is any entity that accepts consumer checks in payment for merchandise or services. Check 106 is any suitable paper personal check presented to a merchant in payment for a purchase. Check 106 may be completely filled out by the customer or it may be completely blank, having only identifying characters along its lower edge for reading by a device. Although check 106 may be any suitable paper check, under current NACHA (National Automated Clearing House Association) rules, certain checks may not legally be used, although technically their use is feasible. For example, under NACHA rules, checks such as corporate checks, government checks, traveler's checks, checks not linked to an ABA demand deposit account, checks drawn on invalid ABA numbers, etc., are not currently accepted within the system. Notwithstanding the above, it is contemplated that as rules are changed, the system may accept additional types of checks.

Present at the point the sale are any number of devices that assist the merchant with reading information from the check and with acquiring information from the customer. Preferably, a MICR (magnetic ink character recognition) device 110 is used to read identifying information from check 106. Alternatively, other devices may be used to either read information from the check or to receive identifying information needed to identify the checking account from which the customer wishes money to be withdrawn. For example, an OCR device 112 may be used to read information from check 106. In other embodiments, check 106 is not present and the customer presents other suitable unique information to identify the checking account from which he or she wishes money to be withdrawn. For example, biometrics reader 114 may be used to uniquely identify the customer and a particular checking account, and checking account information would be contained at a central database. A convenience card is another way to link an account number to a consumer.

Further keypad 108 may be used by the merchant or customer to enter not only identifying information for the checking account, but also information concerning the transaction amount and any other customer identifying information. Keypad 108 may be combined with any of devices 110-114, may be incorporated into a cash register, may be part of a computer, or may be a standalone device. In a preferred embodiment, the merchant swipes check 106 through MICR device 110 which is incorporated into a cash register.

Acquiring bank 120 is a financial institution that contracts with the merchant and directly or indirectly submits check transactions for authorization, clearing and settlement. A processor may also perform these functions on behalf of the acquirer—both are hereinafter referred to as the acquirer or the acquiring bank. Service organization 122 (also termed the “switch” is a financial service organization that accepts messages from acquirer 120 and routes them to either drawee bank 124 or to third party 126. Service organization 122 may be any suitable organization for performing clearing and settlement such as MasterCard, American Express, Discover, etc. In a preferred embodiment, service organization 122 is Visa U.S.A. Inc. of San Francisco, Calif.

Drawee bank 124 is a customer bank that is participating in the POS Check Service and is connected online via a network to service organization 122. The drawee bank is where the customer maintains his or her checking account, and the bank issues checks to the customer. Alternatively, a processor may act on behalf of the drawee bank-both are referred to hereinafter as the drawee bank. Third-party authorizing agent 126 is an entity that authorizes POS Check Service transactions for non-participating banks and creates the corresponding ACH transaction.

FIG. 2 is a flow diagram describing the overall POS Check Service flow. Initially, various setup procedures are preformed by or for the merchant, the acquirer, the drawee bank, the third party and the service organization. These steps typically occur before the service is operational and before a customer performs a transaction. A customer presents a paper check as part of step 154 in which a request is initiated for clearing and settlement; this step is explained in greater detail below.

In step 158 system 100 performs authorization and clearing of the transaction in order to indicate to the merchant whether the transaction is authorized or not; this step is explained in greater detail below. In step 162 the transaction is completed at the point of sale depending upon the results returned. Finally, the transaction is settled in step 166 between the acquirer and either the participating drawee bank or a non-participating bank.

### Detailed Flow Description

FIG. 3 is a flow diagram describing the setup procedures for the POS Check Service. The setup procedures typically occur before the POS Check Service is available to conduct a transaction. Regarding the point of sale, there are various tasks a merchant performs in order to be ready to convert a check at the point of sale. For example, a merchant installs devices at the point of sale that can read MICR, OCR or other data on checks, installs terminals that allow key entry of any additional data, and installs devices for printing a sales draft receipt and to initiate reversals. A merchant also develops or installs a point-of-sale application for use with a check reader that can read and assemble the required information for transmission. Development of these application programs is known to those of skill in the art. A merchant also designates a bank account where electronic check funds can be deposited. Depending upon the telecommunications service used, the merchant works with its acquirer to order and install the required telecommunications configuration, and also works with its acquirer to agree on the settlement process and reconfiguration procedures. The merchant also works with a third party agent to set up parameters for velocity checks (which may also be handled by an acquirer), sets up service options, and performs customer education and clerk training.

The acquirer also performs certain tasks to enable POS Check Service transactions. For example, the acquirer provides hardware and software for communication with a merchant and a service organization which includes the ability to receive, reformat and send POS Check Service transactions. The acquirer also provides a unique merchant identifier for each merchant name and location that originates transactions. The acquirer also selects service options to be supported, etc.

A participating drawee bank is enabled to receive and respond to POS Check Service transactions. Also, the drawee bank is enabled to receive non-parsed MICR data and return parsed MICR data elements in transit routing number and check number fields. The drawee bank also develops a means for reporting POS Check Service transactions on the customer's checking account statements.

In addition to the above setup performed by a participating drawee bank, the third party also performs tasks such as arranging customer support for transactions they deny, arranging settlement with the switch for POS Check Service transactions they authorize and reconciliation of those transactions, setting up service options supported, providing reports or raw data for reporting, creating an ACH file on behalf of the acquiring banks, and providing additional services to acquiring banks, such as image archiving and collection services.

FIG. 4 is a more detailed illustration of paper check 106. As described above, check 106 may be any suitable personal check or even other types of checks as permitted by law. On the lower edge of check 106 is a line of information 252 commonly termed the MICR (magnetic ink character recognition) data. Included within this line are separation characters 254, 258, 262 and 266 which separate the various pieces of information. Information 256 is a sequence of characters that is the transit routing number, also termed the ABA number. Information 260 is a sequence of characters identifying the customer's account number, termed the on-us data. Information 264 is a sequence of characters identifying the serial number of the check. As separators 254, 258, 262 and 266 are symbolic characters (also termed “nonprintable characters”), they are typically translated later into alphanumeric characters. When the separators in the MICR data are later translated into alphanumeric characters, they are typically translated to the characters “T”, “O”, “A” and “D” which is referred to as the raw TOAD format. Translation occurs because a computer systems cannot understand nonprintable characters, and this simple substitution allows the system (or another system) to eventually parse the information.

FIG. 5 is a flow diagram describing how a request is initiated to convert a check at the point of sale. At this point in time, a customer is performing a transaction with a merchant and desires to make a purchase using a paper check for payment. In step 202 the clerk enters the amount of the transaction into one of the devices described in FIG. 1. Of course, this amount may also be entered by the customer or may in some instances by automatically entered into a cash register using scanning or other known techniques. In step 206 the customer presents a paper check for payment. The check is in payment for goods or services and may not be filled out. The customer may receive cash back if the POS Check Service transaction is keyed for an amount above the purchase price. The cash back amount is uniquely identified in the POS Check Service authorization message.

In step 310 the check is swiped through one of the devices described in FIG. 1. Preferably, the check contains MICR data and is swiped through a MICR device. Next, the device reads the raw MICR data from the bottom of the check in step 314. This data will include the transit routing number, the account number of the customer and the check serial number. The device translates the symbols into the appropriate alphanumeric characters (raw TOAD format). This translation may also occur at the acquirer. This translation occurring at the device or at the acquirer is not an actual parsing, it is simple substitution of familiar alphanumeric characters for nonprintable separation symbols. The translation assumes no knowledge about the structure of the MICR encoded information other than recognizing which nonprintable symbol matches with which alphanumeric character. As mentioned earlier other devices and readers may be used to obtain the necessary information for the paper check and in certain embodiments the paper check is not required but the identifying information is entered via a keypad or other means herein described.

In an optional step, in step 322 additional customer information is entered into the device. This additional customer information may include identification such as driver's license number, state identification number, military identification number, etc. Various types of customer information are presented in Table 1. This information is optional and variable and depends upon the individual requirements of the participating merchant, acquirers and third-party authorizing agents.

As shown in Table 1, the processing code is used to identify the type of POS Check Service transaction that the merchant desires. A merchant may request that a check be converted, be verified and converted, or be guaranteed and converted. If a merchant requests Conversion Only, the transaction will be approved or declined by a participating bank on which the check is drawn or by a third-party authorizing agent with minimal account verification processing. If the merchant chooses Verification with Conversion, the request method will be routed to a participating bank on which the check is drawn or to an authorizing agent for verification of the probability that the check will be paid based on information available at the time of the request. The merchant will then receive either an approval or decline response. If the merchant chooses the Guarantee with Conversion option, the request message will be routed to a participating bank on which the check is drawn or to an authorizing agent to guarantee the check. The merchant will then receive either an approval or decline response.

TABLE 1
Additional Customer Data—Private

| Field Name | Usage |
|---|---|
| ID Type and | Identifies the type and number of the customer identification present at |
| Number | the point of sale. Used in the request. This field may be repeated as |
| | often as necessary, if information from multiple ID types is captured at |
| | the point of sale. The first two positions in this field are either a valid |
| | state code or an ID Type such as Military ID, Courtesy Card, social |
| | security number, proprietary card, military base, embassy or traveling |
| | merchant. If the value in the first two positions is a valid state code, then |
| | the number following it is either a valid driver's license number or State |
| | ID. If the value in the fist two positions is a valid ID Type, then the |
| | number following it corresponds to the ID Type presented. |
| Date of Birth | Identifies a date of birth, field length, and contents. Used in the request. |
| Telephone | Identifies a telephone number, field length, and contents. Used in the |
| Number | request. |
| Response | A one-digit response source identifier returned by a non-bank authorizer |
| Source | in all responses. Used in the response. |
| Reference | Identifies a reference number of any type, field length, and contents. |
| Number | Used in the response. |
| Proprietary | Identifies proprietary response information defined by an authorizing |
| Response | agent, field length, and contents. Used in the response. |
| Information | |
| Receipt | Identifies customer receipt information, field length, and contents. Used |
| Information | in the response. |
| Call Back | Contains non-bank authorizer name, address, and customer service |
| Information | telephone number. The field is preferably returned by non-bank |
| | authorizers on declines of original requests. Used in the response. |

In step 326 the request message is built using the assembled information. The message can be assembled at the merchant or at the acquirer, but is typically assembled before being transferred to the service organization. The merchant also determines which service it desires, i.e., Conversion Only, Verification with Conversion or Guarantee with Conversion. Regarding the different methods of service, a merchant may choose Conversion Only because his main objective is to eliminate paper processing and he anticipates a low-risk with the item. If a merchant is concerned about the authenticity of a check and wants to verify that funds are present in the customer's checking account at the time of purchase, the merchant may choose Verification with Conversion because there is a greater likelihood that the merchant will be paid. If a merchant wants guaranteed payment of the item, he may choose Guarantee with Conversion, in which case the guarantor bears the liability even if the check is not honored.

The POS Check Service message may be assembled using any desired format until it reaches the host connected to the service organization, at which point it must be formatted into the standard message format of the service organization, and includes such information as a merchant terminal identifier, a merchant identifier, a third-party identifier, the amount of cash back desired, the RAW TOAD MICR data, the transaction amount, terminal capability information, information sufficient for clearing and settlement, and an indication of the service desired by the merchant. A list of possible information is presented in Tables 2 and 3. Other data fields include: Bitmap, secondary; transmission date/time; Systems trace audit number; local transaction time; local transaction date; settlement date; merchant type; acquiring institution country code; acquiring institution ID code; retrieval reference number; card acceptor terminal ID; card acceptor ID code; card acceptor name/location; transaction currency code; national POS geographic data; network ID code; acquirer business ID; receiving institution ID code and additional trace data.

TABLE 2
Request Message

| Field Name | Use | Suggested Data Requirements |
|---|---|---|
| Processing Code | Identifies the type of POS | Guarantee with Conversion = |
| | Check Service transaction. | 03. |
| | | Verification with Conversion = |
| | | 04. |
| | | Conversion Only = 18. |
| Transaction Amount | Amount of transaction. | |
| Point of Service Entry | Identifies the method used | |
| Mode Code | to capture the MICR data. | |
| POS Condition Code | Serves as an identifier, in | The POS Condition Code for |
| | conjunction with the | POS Check Service transactions |
| | Processing Code. | is 52 on all original full financial |
| | | transactions. |
| Check Settlement Code | Provided by the service | Switch Settlement Code = 1. |
| | organization in responses to | ACH Settlement Code = 2. |
| | indicate the settlement | Field not be present if the item |
| | disposition of the | will not be settled. |
| | transaction. | |
| Additional Customer Data- | May be used for any | See Table 1. |
| -Private | customer identification | |
| | information specifically | |
| | required by an authorizer. | |
| Additional POS Data | A private-use field defined | |
| | by the service organization | |
| | to provide additional | |
| | information about the point | |
| | of sale or service. | |
| Other Amount, | Should contain the cash | The cash back amount should |
| Transaction | back amount from the | not exceed the Transaction |
| | transaction, if any. | Amount. |
| Transaction Identifier | Will contain a unique | This field will be sent to |
| | transaction identifier | transaction recipients and |
| | assigned by the service | returned to transaction |
| | organization. | originators. |
| Receiving Institution ID | Contain the BIN ID of the | If the check is drawn on a |
| Code | third-party authorizer that | participating drawee bank, the |
| | the originator wants to | service organization will route |
| | receive the transaction. | the transaction to that bank. |
| | | Otherwise, the transaction will |
| | | be sent to the designed third- |
| | | party authorizer. |
| Supporting Information | Contains the MICR | See Table 3. |
| | information from the | |
| | customer's check. | |

TABLE 3
MICR Information

| Field Name | Data Content | Format |
|---|---|---|
| Data Type | RM | Identifies the data contents as |
| Identifier | | unformatted MICR information. |
| Data | 999 | Indicates the length of the MICR data |
| Length | | contained in the field. |
| Identifier | | |
| MICR | Contains the unaltered contents of | The unformatted MICR data is |
| Information | the MICR line, with spaces | preferably the same MICR line from the |
| | preserved, read from the customer's | check, including spaces, except that the |
| | check by a terminal. At a minimum, | MICR symbols should be replaced as |
| | the Transit Routing Number and | follows: |
| | Customer Account Number (On-us | The Transit symbol is replaced by the |
| | field) should be present. | letter “T” in either upper or lower case. |
| | Refer to Understanding and Design | The On-us symbol is replaced by the |
| | Checks, ANSI Standard X9/TG-2 | letter “O” in either upper or lower case. |
| | (1990). | The Dash symbol is replaced by the |
| | | letter “D” in either upper or lower case. |

FIGS. 6A, 6B and 6C are a flow diagram describing the authorization and clearing of a transaction. Once a complete POS Check Service request message has been received by the host, and has been reformatted, the host sends the request message online to the service organization (switch) for central processing and routing to an authorizing endpoint. In step 402 the host reformats the message and sends it to the service organization. This reformatting is done in order to be in compliance with the switch interface specifications.

In step 406 the switch performs exclusion checking on the request. As part of the switch processing, a limited ABA exclusion verification is applied. In one embodiment, an ABA exclusion table is used. If the authorization request contains an ABA number (the transit routing number) that is included in the ABA exclusion table, the switch will immediately return a decline response to the host with an appropriate response code. Included in the exclusion table are ABA numbers that identify government checks (J.S. Treasury and Federal Reserve), traveler's checks, or an instrument with a non-check ABA number. ABA numbers are known to one of skill in the art and the table may be edited to exclude any types of checks based upon an ABA number. Preferably, the switch or its agent should be able to add or delete ABA numbers from the repository of online exclusion and offline translation data. These data repositories should be updated not less than daily.

Preferably, the ABA number is extracted from the raw TOAD format MICR data without the need for parsing the data. Because it is known that ABA number is bounded by the “T” tag and is nine digits long, it is simple to extract the number for exclusion checking and later routing. Essentially, the switch “looks” at the ABA number but does not perform parsing (although it is possible for parsing to occur here).

Preferably, the service organization also edits the transaction request to ensure valid data formats, and to insure the transaction complies with the business rules governing the service. Other checks such as duplicate checking are performed. The switch performs duplicate checking on originals to ensure merchants and acquirers do not submit identical requests. If the transaction passes these edits and checks, the service organization forwards the transaction to either a participating bank on which the check is drawn or to a third-party authorizing agent.

Based upon a list of participating banks, in step 410 the switch attempts to match the transit routing number with that of a participating drawee bank. If there is a match, then in step 414 the switch determines whether the service requested of the merchant matches a service provided by the drawee bank. If so, then in step 418 the settlement code in the request message is set to a “1” (or other symbol) to signify that settlement will eventually occur through the switch. The switch also generates a unique transaction identifier for the current transaction in step 430. Preferably, all transactions have an audit trail which ties together related transactions in a transaction set-thus, future reversals, voids, etc. can all be related to the original transaction. The unique transaction identifier may be used for this purpose. Next, this request message is sent to the participating drawee bank in step 434. If the switch determines the drawee is unavailable, a response for “Service Not Available” is sent to the merchant's acquirer.

In step 438, the bank handles the request as per the service requested by the merchant. The raw TOAD MICR data is first parsed as explained below. If Conversion Only is requested, then the bank may merely check to see that a valid account does exist at the bank, that the account has not been closed, and that the account is not fraudulent. (If invalid, a “Do not Honor” response is returned to the merchant's acquirer.) The bank is not obligated to perform further checking or verification. When Verification with Conversion is requested, then in step 454 the bank not only verifies that the account is valid, but also that the amount of funds in the account is adequate for the transaction. In a preferred embodiment, a bank will also place a hold upon the account for the transaction amount in this step. If Guarantee with Conversion is desired, then in step 462 the bank will place a hold on the account for the amount of the transaction and will guarantee that the amount will be paid. In other words, the bank must pay the amount regardless of the account balance.

Next, the bank generates a response message and returns it to the service organization. This response message contains a variety of information concerning the transaction; an example response message is shown in Table 4. Included within the response message is a response code generally indicating whether the request is approved. Examples of response codes are shown in Table 5. Table 5 shows the business reason for the response, response code, whether the response is approved or declined, and the responding endpoint eligible to use each of the codes. Once switch 122 receives the response message, it determines if there is an approval in step 470.

TABLE 4
Response Message Fields

| Field Name | Data | Format |
|---|---|---|
| Response Code | Contains a Response | |
| | Code valid for POS | |
| | Check Service | |
| | transactions as shown | |
| | in Table 5. | |
| Additional Data, | No data is required in | Any data that a check request respondent |
| Private | this field. | chooses to include in the message should be |
| | | formatted as shown in Table 1. |
| Support | This field contains: | The POS Check Service field identifier appears |
| Information | $V | in the first two types of the field, as shown. |
| Field Identifier | | |
| Transit Routing | The drawee bank's | The POS Check Service field identifier appears |
| Number | Transit Routing | in the first two bytes of the field, as shown. |
| | Number (ABA | The Transit Routing Number has a fixed length |
| | Number). | of 9 numeric characters and may be formatted |
| | | as follows: AB999dddd, where AB identifies |
| | | the sub-field, 999 the length of the data, and |
| | | dddd, the actual data contents. |
| Customer | The customer deposit | The customer deposit account number should |
| Account Number | account number | be present, a maximum of 19 characters and |
| | | preferably formatted as follows: |
| | | AN999dddd, where AN identifies the sub- |
| | | field, 999 the length of the data, and dddd, the |
| | | actual data contents. |
| Check Serial | The check serial | The check serial number should be present, a |
| Number | number of the check | maximum of 15 characters, and preferably |
| | being converted. | formatted as follows: CK999dddd, where CK |
| | | identifies the sub-field, 999 the length of the |
| | | data, and dddd, the actual data content. Any of |
| | | the alpha characters sent in this field in the |
| | | request message (“t”, “o”. “d”) should be |
| | | stripped out when the field is returned. |

TABLE 5
Response Codes

| | Response | Approve/ | Service | Non-bank | Participating |
|---|---|---|---|---|---|
| Business Condition | Code | Decline | Organization | Authorizer | Drawee Bank |
| Unconditional | 00 | A | | Y | Y |
| Approval | | | | | |
| Invalid merchant ID | 03 | D | | Y | |
| Do not honor | 05 | D | | Y | Y |
| Invalid account | 14 | D | | Y | Y |
| No such issuer | 15 | D | Y | | |
| NSF | 51 | D | | Y | Y |
| Transaction not | 57 | D | Y | Y | Y |
| permitted | | | | | |
| Too much cash (over | 61 | D | | Y | Y |
| merchant or bank | | | | | |
| limit) | | | | | |
| Exceeds withdrawal | 65 | D | | Y | Y |
| frequency limit | | | | | |
| Unsolicited reversal | 76 | D | Y | | |
| Reversal received | 80 | D | Y | | |
| form denied request | | | | | |
| Issuer unavailable | 91 | D | Y | | |
| Routing error | 92 | D | Y | Y | Y |
| Duplicate | 94 | D | Y | | |
| Transaction | | | | | |
| System error | 96 | D | | Y | Y |
| Approval, keep first | T0 | A | | Y | |
| check | | | | | |
| Check is OK, but | T1 | D | | Y | |
| check cannot be | | | | | |
| converted | | | | | |
| Invalid Transit | T2 | D | Y | Y | |
| Routing Number | | | | | |
| Amount greater than | T3 | D | | Y | |
| established service | | | | | |
| limit | | | | | |
| Unpaid items, failed | T4 | D | | Y | |
| negative file check | | | | | |
| Duplicate check | T5 | D | | Y | Y |
| number | | | | | |
| MICR error | T6 | D | | Y | Y |
| Too many checks | T7 | D | | Y | Y |
| (over merchant or | | | | | |
| bank limit) | | | | | |

Returning for a moment to the “NO” branches of steps 410 and 414, if the transit routing does not match the table of participating banks, or the service requested by the merchant does not match the service provided by the participating bank, then in step 484 the settlement code in the request message is set to a “2” (or other suitable symbol) to signify that settlement will be through ACH because a third-party authorizing agent is used. The following steps describe actions occurring when the authorization request is sent to the third-party authorizing agent 126 in step 485. In some ways, the request is handled in a similar fashion as the participating drawee bank handles the request as described in FIG. 6B. Because the third party, however, does not have control over the customer's account, it must use other means to provide verification and guarantee. In step 486 the request is handled as per the service request. The raw TOAD MICR data is first parsed as explained below. If the request is for Conversion Only, then in step 488 the third party, at a minimum, verifies that the check is eligible to be converted into an ACH item.

If the request is for Verification with Conversion, then in step 490 the third party, at a minimum, performs velocity checks, searches their database of returned checks, verifies against risk models, etc., to determine the probability that the POS Check Service transaction amount will be paid by the customer's bank. If the request is for Guarantee with Conversion, then in step 492 the third party performs velocity and database checks and will underwrite the amount of the request, guaranteeing payment even if the item is returned. Finally, in step 493 the third party generates a response message in much the same way as in step 466 and sends the response to the service organization.

Returning to step 470 of FIG. 6B, once the response message has been received by the service organization, it determines whether the transaction has been approved. More specifically, switch 122 processes response messages as shown in Table 6. If the transaction has been approved, the message is sent to the acquirer or merchant host who then reformats the message into the protocol used with the merchant, and sends the response message back to the merchant. If the transaction was not approved, the switch first removes the settlement code in step 478, indicating that the item is not settled, before sending the response message back to the acquirer or merchant. Once the response message is received by the merchant, the transaction is then completed at the point of sale as described below.

TABLE 6
Switch Processing of Response Messages

| Field Name | Contents | Switch Processing |
|---|---|---|
| Response | The Response Code | If the Response Code is not valid, the switch will |
| Code | should be valid for POS | reject the transaction and will send a “decline” |
| | Check Service | response to the originator of the response, with |
| | transactions and valid | Response Code 91. |
| | for the sending party, as | |
| | shown in Table 5. | |
| Check | Switch will add under | If the response message carries an approval |
| Settlement | certain conditions. | Response Code and passes all Switch edits, the |
| Code | | Switch will add this field, indicating the |
| | | settlement type for the transaction. A value of 1 |
| | | means that the Switch will settle the transaction. |
| | | A value of 2 means that the transaction will settle |
| | | through the Automated Clearing House (ACH). |
| Transaction | Contains the | The Switch will restore the Transaction Identifier, |
| Identifier | Transaction Identifier. | if it is not returned in the response message. |
| Supporting | Contains the Transit | The Switch will edit the field for presence, correct |
| Information | Routing Number, the | formatting and required data. If the field is not |
| | Customer Account | present, the Switch will reject the transaction. If |
| | Number, and the Check | the transaction is approved and if the required |
| | Serial Number. | Transit Routing Number, Customer Account |
| | | Number, and Check Serial number are not |
| | | present, or the formatting of the field is incorrect, |
| | | the Switch will reject the transaction. If the |
| | | transaction is approved and if the Transit Routing |
| | | number does not match the Transit Routing |
| | | Number submitted on the original request, the |
| | | Switch will reject the transaction. |
| | | If the transaction is declined, the Switch will not |
| | | edit for the presence of this field. |

As mentioned above in steps 438 and 486, parsing is first performed on the raw TOAD MICR data before the service request is handled. Although it is possible to perform parsing at the MICR reader, it is preferable to parse at the drawee bank or a third party authorizer. Because there are many different MICR readers on the market of varying quality and implementation, parsing MICR information at the MICR Reader level is prone to numerous errors. These errors can result in increased problems authorizing transactions and lengthen transaction times, which leads to consumer and merchant dissatisfaction. This embodiment of the present invention chooses to move the parsing of MICR data to the authorizer of the transaction.

Parsing implies knowing the rules for extracting the ABA number, the account number and the check serial number from the MICR line. There are potentially thousands of rules for account number structure and various ways for encoding the check serial number in the MICR line. To fully parse the MICR line requires building a table of these rules or buying such a table from a provider. Third party authorizers have years of experience in building databases of proprietary parsing rules, likewise, drawee institutions are in the best position to determine the account information from the MICR line as they are the account holder. Moving parsing from the point-of-sale terminal to an authorizer avoids unnecessary service errors up front and places parsing at a point in the transaction flow which ensures the greatest success of successfully parsing the MICR information. This leads to an improved consumer and merchant experience at the point of sale and delivers financial benefits because it increases the number of successful check conversion transactions.

Preferably, parsing is performed at a drawee bank or at a third party authorizer using known techniques. The drawee bank or authorizer first receives the incoming request, extracts the MICR information and processes it against their existing database of MICR line structures. Typically, the bank or authorizer uses proprietary tables and databases of known line structures to extract out the routing and transit information, account number and check serial number. One of skill in the art familiar with these parsing techniques would be able to extract the necessary information from the MICR line.

FIG. 7 is a flow diagram describing the completion of a transaction at the point of sale. At this point, the merchant has received a response message from the acquirer and will complete the transaction with the customer. Based upon the response code in the response message, the merchant is advised as to whether the transaction has been approved or declined. Preferably, based upon this information, the merchant will either accept or reject the customer's check. Even if the transaction has been declined, however, the merchant may still decide to accept the customer's paper check like a normal check transaction, i.e., not converting the check into a electronic transaction.

Assuming that the transaction is approved, the merchant then stamps the customer's check “VOID” and returns the check to the customer. The POS Check Service uses a Consumer-As-Keeper model, and therefore, the merchant does not keep the paper check, but returns it to the customer. In step 510 the merchant generates a receipt for the customer; one such example of a receipt is shown in FIG. 8. Finally, in step 514 the customer signs a copy of the transaction receipt which is retained by the merchant. This signed receipt proves that the customer has authorized the paper check to be converted into an electronic transaction.

FIG. 9 is a flow diagram describing the settlement of transactions. At the end of each day, the acquirer is aware of all transactions from its participating merchants. Typically, the acquirer then reconciles the transactions for all merchants in step 550 and notifies merchants when settlement funding will occur. Also, an acquirer may choose to pre-fund a merchant for a particular transaction depending upon the type of the transaction and/or the type of merchant. The merchant will receive such settlement information informing the merchant of how to expect payment. For example, in step 554 the merchant receives information uniquely identifying any checks written to the merchant that have been converted into an electronic transaction.

In step 558 settlement is performed. As is known in the art, typically at the end of each business day at 10:00 p.m., the service organization looks at the difference between debits and credits and calculates net settlement for all participants. A federal wire transaction is initiated to then move money between settlement accounts. Eventually, an acquirer will distribute payment to each of its merchants. As mentioned earlier, the settlement code can be used by the acquirer and merchant to understand where payment will be coming from. For example, if a batch of checks is converted using the present invention and are identified as being handled by an ACH transaction, the merchant will then realize that it may take a day longer for settlement to occur.

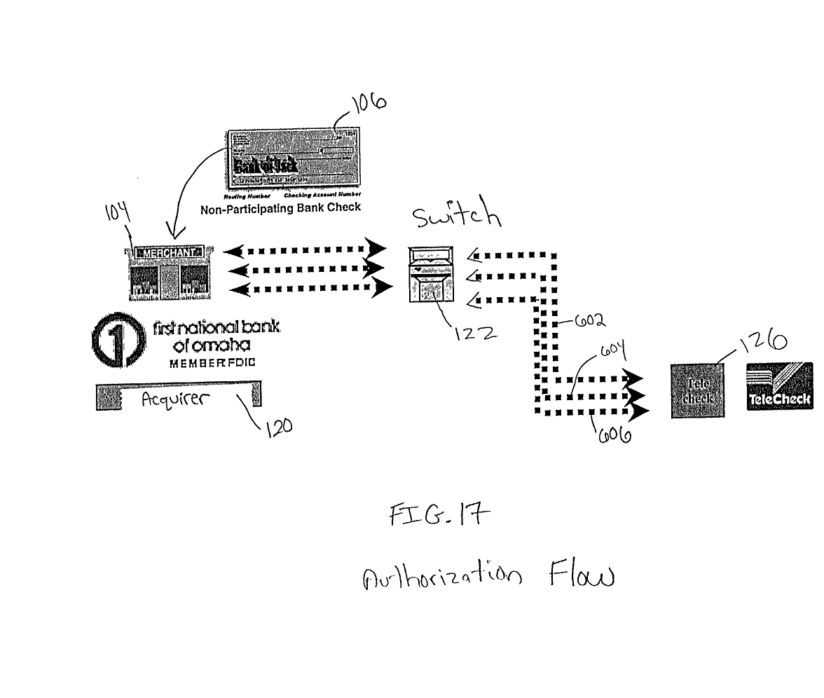

As mentioned above, the means of settlement is determined at the time of authorization based on how the transaction is routed for authorization. POS Check Service transactions authorized by a participating drawee bank are settled through the service organization. POS Check Service transactions authorized by a third-party authorizing agent are settled through the ACH network. Various embodiments for settlement step 558 are presented below. Switch 122 is arranged to provide any of a variety of activity reports detailing settlement that are tailored for merchants, acquirers, drawee banks, etc. These reports include all POS Check Service transactions, both those settled through the Switch, and those settled through the ACH. An example of an activity report for a participating drawee bank is shown in FIG. 18.

### Settlement Embodiments

FIG. 10 illustrates the settlement process for transactions settled via the service organization or switch. The flow shows one transaction, but represents the delivery of batches of POS Check Service transactions to multiple acquirers/processors and participating drawee banks. Settlement files are exchanged daily for approved POS Check Service transactions that the switch has exchanged with participating drawee banks. If the same BIN is used for activity other than POS Check Service transaction processing, the POS Check Service settlement total will be combined with the settlement total for other activity processed by the switch.

For POS Check Service transactions authorized by participating banks at the end of the day, numerous tasks are performed. The switch provides settlement information to acquirers and participating drawee banks. The switch also sends raw data and reports to acquirers and participating drawee banks. Acquirers reconcile the credit amount to their merchants' accounts and drawee banks apply debits and credits to their customer's checking accounts.

FIG. 11 illustrates the settlement process for POS Check Service transactions via the ACH. (Authorization already having occurred via the system shown in FIG. 1, for example.) For settlement of transactions drawn on non-participating banks, the ACH enables the routing of transactions to the specific acquirer or RDFI (Receiving Depository Financial Institution). In this context, an RDFI is a financial institution that receives a POS Check Service transaction and debits it from the customer's checking account. POS Check Service transactions exchanged by the switch and third-party authorizing agents are settled by the ACH. All post-settlement items relating to the transactions are processed according to the ACH rules published by NACHA.

For POS Check Service transactions authorized by a third party, certain tasks occur at the end of the day. First, the third party sends its data to the ODFI (Originating Depository Financial Institution). Next, the ODFI processes all On-Us transactions and forwards all non-On-Us transactions to the ACH. The ACH then forwards all debits to the RDFI. The ACH forwards all credits to the acquirer. The RDFI will forward the debit to the customer's checking account and the acquirer sends the credit amount to its POS merchant.

FIG. 12 illustrates a settlement flow for a participating drawee bank. Shown is the flow for a request message, a response message, and settlement when the check to be converted is drawn upon a participating bank 124.

FIG. 13 illustrates a settlement flow through the ACH for a non-participating drawee bank. In this situation, the switch 122 has purchased a third-party authorizing agent and performs the ACH processing in-house. Thus, the switch not only handles authorization of the transaction, but also initiates the request to the ACH and ODFI for settlement between the acquirer 120 and drawee bank 124.

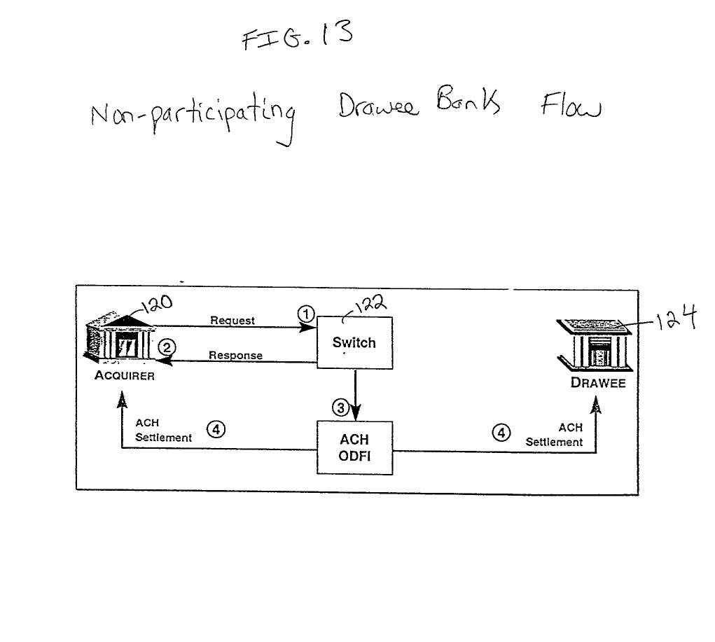

FIG. 14 illustrates an alternative flow for a non-participating drawee bank. In this example, the converted check is drawn on a non-participating drawee bank, thus causing the third party to perform authorization. In this situation, though, the request for ACH settlement comes from the switch and not from the third party.

### Authorization Embodiments

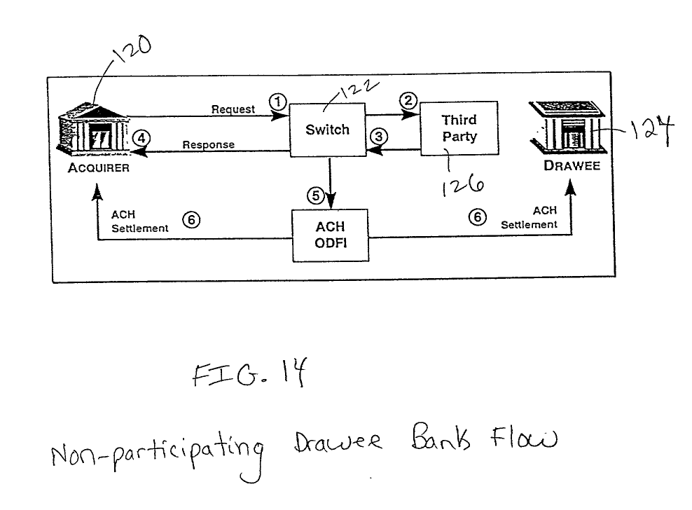

FIG. 15 illustrates an example of an authorization flow in which the acquirer and the drawee bank are the same. In this example, the merchant acquirer bank 120 is the same as the drawee bank 124 on which the customer's check 106 is to be drawn. Service request for Conversion Only 602 and Guarantee with Conversion 606 are directed to the drawee bank which supports them, while a request for Verification with Conversion 604 is directed to a third party 126 approved by the acquirer because the drawee bank does not support this service.

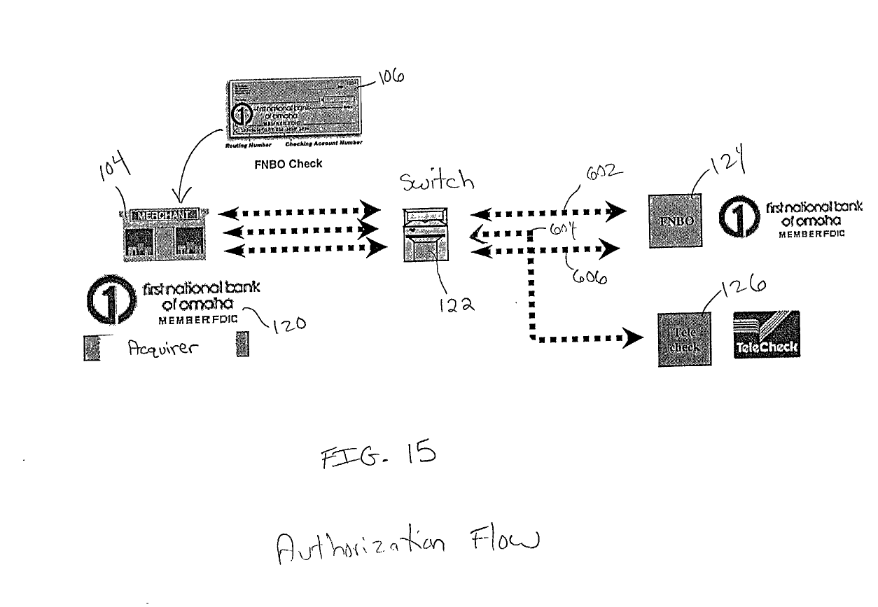

FIG. 16 is an example of an authorization flow in which the acquiring bank is not the same as the drawee bank. In this example, the merchant's bank 120 is different from drawee bank 124 upon which the customer's check 106 is to be drawn. Service request for Conversion Only and Verification with Conversion, 602 and 604, are directed to and authorized by drawee bank 124 because it supports these services. The drawee bank does not support Guarantee with Conversion, thus, a request for this service is routed to and authorized by third party 126.

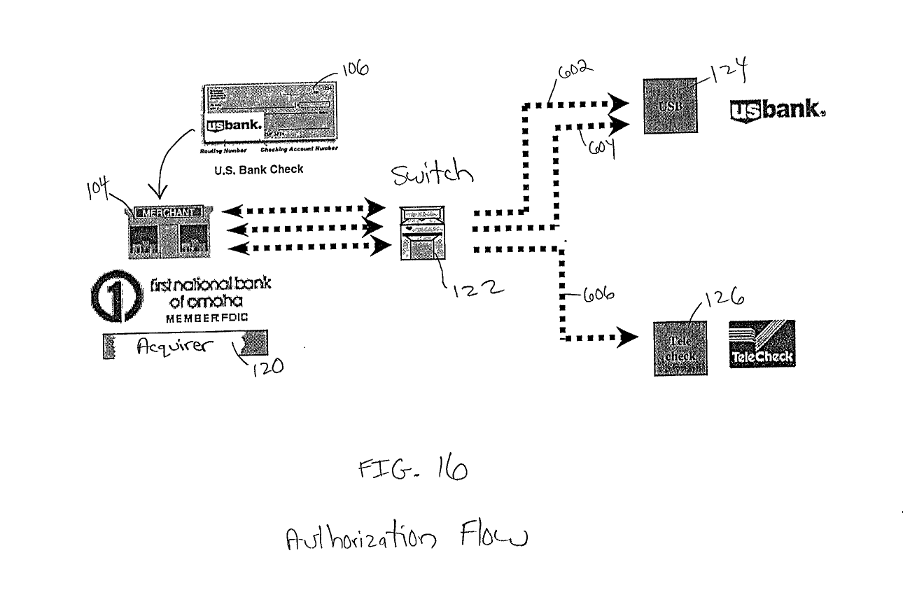

FIG. 17 is an example of an authorization flow in which the customer's check 106 is to be drawn on a bank which does not participate in the POS Check Service. In this example, check 106 is drawn on the fictitious Bank of Jack which is different from the acquiring bank 120. Because the Bank of Jack does not participate in the POS Check Service, all service requests 602-606 are routed to and authorized by third party 126.

FIG. 18 is an example of an activity report for a participating drawee bank as referenced above.

### Point of Transaction Alternative Embodiments

In any one of many alternative embodiments, the POS Check Service can be adapted as explained below to function not only as a “point-of-sale” check service, but also as a “point-of-transaction” check service. The service described above is termed a “point-of-sale” service in that the check is being surrendered to the merchant by the customer at the point of sale. There are, however, other situations in which a sale is being made, and a customer would wish to pay by check, yet the customer is not presenting a paper check in person. These situations can be termed a “point of transaction” and include situations in which a customer mails in a check or in which a customer uses a check over the Internet.

In the first scenario, the customer desires to purchase a product or service from a merchant but instead of appearing in person and presenting the check (as shown in FIG. 1), the customer may simply mail the check to the merchant along with an EFT authorization form as part of the order form. The customer is either aware of the amount of the product or service, or indicates somehow in the correspondence how much the check should be written for. The merchant would then process the check as has been described above in FIG. 5. In other words, the merchant swipes the check through a reader, enters the amount of the transaction and sends the information off. If other identifying information is required of the customer the merchant may request this ahead of time, the customer may present this information in the correspondence, the merchant may keep this information on file for the customer, or the merchant may telephone or write back to the customer in order to get the information, etc. In any case, any further customer identifying information needed by the merchant to complete the transaction can be readily obtained from the customer even though the customer is not present in person.

The customer may even complete a transaction using a check over the Internet. Once a customer has determined a product or service to buy on the Internet, a series of questions or screens on the web site directs the customer to enter the appropriate information from the paper check. In this situation, the customer would view one of their own paper checks in front of the computer and type in the MICR line information as requested by the web site. In other words, the customer at home is essentially parsing the MICR line themselves and providing the ABA and account number to the web site. The web site may also ask for any other needed identifying information of the customer, including the amount of the transaction, etc. Thus, in these two situations a point-of-transaction check service is provided in which a customer makes a purchase using a check without being present in person at the merchant's location of business.

In another scenario, a person may wish to make a deposit to their checking account at an ATM using a check from someone else or perhaps their own check. Typically, the check is a payroll check to the customer. In fact, the customer may even make a deposit to their own account using one of their own checks. In this situation, the customer inserts the paper check at the ATM where it is read internally by any of the devices described in FIG. 1 or the customer may also swipe the paper check through a suitable reader on the outside of the ATM. The check may be returned to the consumer or may be held internally, but the paper check is not needed as a negotiable instrument as described above. Once the check has been inserted, the customer keys in the amount to be deposited or the deposit amount may be read from the check itself using OCR technology. Once the check has been inserted (or swiped) and the amount to be deposited received, processing continues as described in FIG. 5. In this situation the customer enters their own account number to be credited and it is this account at the customer's bank which is treated as if it were the merchant's account as has been described above. Thus, a customer may deposit a check to their own account using the techniques described above. In fact, any person can present a check in this fashion at an ATM and indicate that it be deposited to any valid account simply be keying in the account information. The check to be deposited need not be directed toward the account of the person inserting the check in the ATM.

In a similar situation, a customer may wish to put money into a brokerage account using a paper check. In this situation the customer tenders a paper check to their broker who behaves as a merchant may and processes the check as described being in FIG. 5. The recipient of the amount to be deposited would not be the brokerage firm itself in this case, but would be a brokerage account of the customer located with the particular brokerage firm.

In either of the above scenarios, ATM deposit or brokerage account deposit, the entity accepting the deposit (like the merchant accepting payment described above) will initiate an electronic request to debit the check writer's account. The debit to the check writer's account will follow the same processing as it will under the point of sale scenario. The advantage is that the bank or brokerage can simply initiate an online debit request instead of moving the paper through the system. This speeds up receipt of the funds and also helps ensure payment on the check that was deposited. Thus, in the above two scenarios a customer is able to use a point-of-transaction check service in order to make a deposit originating with a paper check.

### System Hardware Embodiment

In one embodiment of the invention, a particular infrastructure provides the data processing systems, networks, and operations to support and deliver authorization, clearing and settlement services for the POS Check Service.

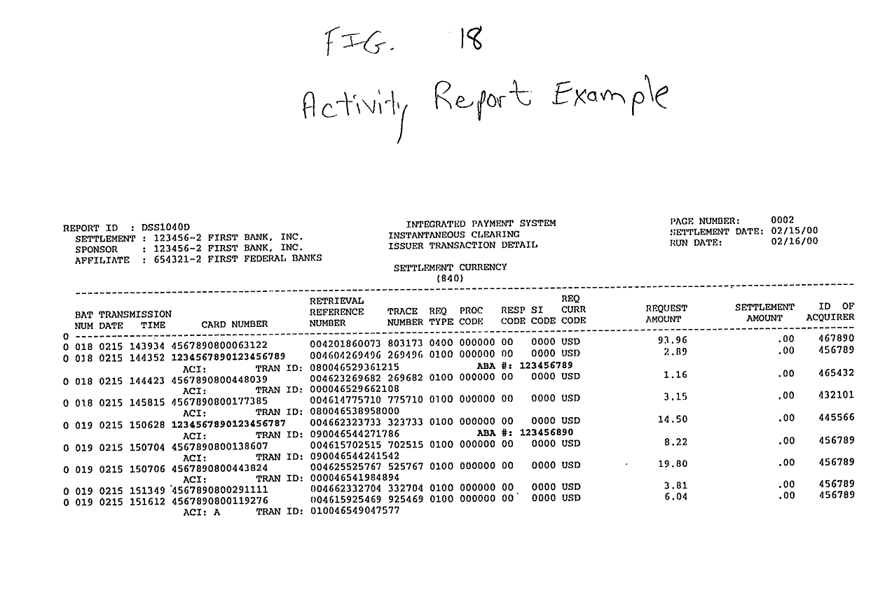

FIG. 19 illustrates a telecommunications network 800 suitable for implementing an embodiment of the present invention. The present invention may make use of any suitable telecommunications network and may involve different hardware, different software and/or different protocols then those discussed below. The below-described network is a preferred embodiment. Network 800 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice-the first time with only information needed for an authorization decision, an again later with additional information for clearing and settlement. A single message transaction is sent once for authorization and contains clearing and settlement information as well. Typically, authorization and clearing all occur online.

The main components of telecommunications network 800 are interchange centers 802, access points 804, 806 and processing centers 808 and 810. Other entities such as drawee banks and third-party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, lines 820 and 822 that connect an interchange center to remote entities use dedicated high-bandwidth telephone circuits or satellite connections based on the IBM SNA-LU0 communication protocol. Messages are sent over these lines using any suitable implementation of the ISO 8583 standard.

An access point 804 or 806 is typically a small computer system located at a processing center that interfaces between the center's host computer and the interchange center. The access point facilitates the transmission of messages and files between the host and the interchange center supporting the authorization, clearing and settlement of transaction. Links 826 and 828 are typically local links within a center and use a proprietary message format as prefer by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

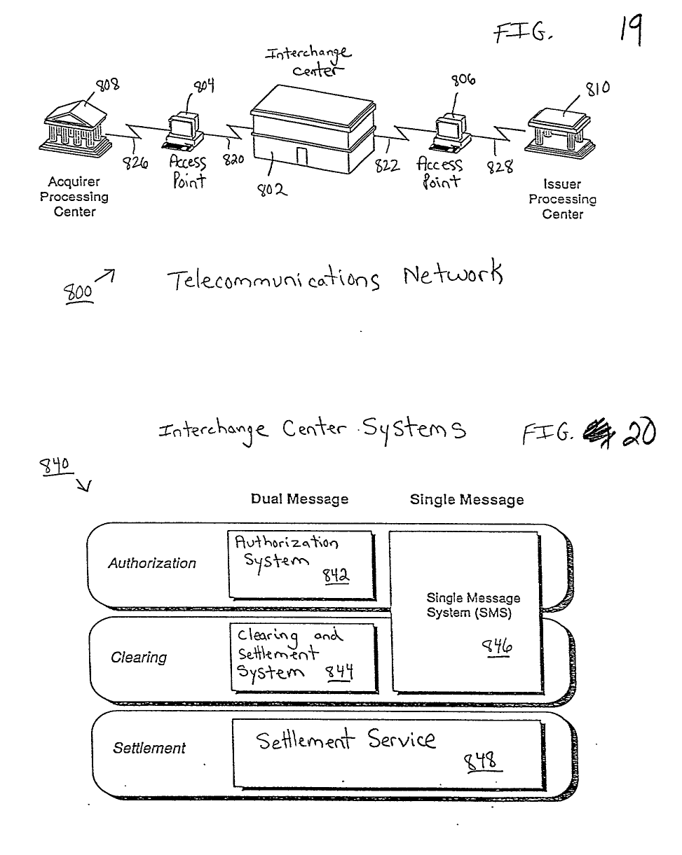

FIG. 20 illustrates systems 840 housed within an interchange center to provide online and offline transaction processing. For a dual message transaction, authorization system 842 provides authorization. System 842 supports online and offline functions, and its file includes internal systems tables, a customer database and a merchant central file. The online functions of system 842 support dual message authorization processing. This processing involves routing, cardholder and card verification and stand-in processing, and other functions such as file maintenance. Offline functions including reporting, billing, and generating recovery bulletins. Reporting includes authorization reports, exception file and advice file reports, POS reports and billing reports. A bridge from system 842 to system 846 makes it possible for members using system 842 to communicate with members using system 846 and access the SMS gateways to outside networks.

Clearing and settlement system 844 clears and settles previously authorized dual message transactions. Operating six days a week on a global basis, system 844 collects financial and non-financial information and distributes reports between members. It also calculates fees, charges and settlement totals and produces reports to help with reconciliation. A bridge forms an interchange between system 844 processing centers and system 846 processing centers.

Single message system 846 processes full financial transactions. System 846 can also process dual message authorization and clearing transactions, and communicates with system 842 using a bridge and accesses outside networks as required. System 846 processes Visa, Plus, Interlink and other card transactions. The SMS files comprise internal system tables that control system access and processing, and the cardholder database, which contains files of cardholder data used for PIN verification and stand-in processing authorization. System 846 performs online, real-time cardholder transaction processing and exception processing for authorization as well as full financial transactions. System 846 also accumulates reconciliation and settlement totals. System 846 offline functions process settlement and funds transfer requests and provide settlement and activities reporting. Settlement service 848 consolidates the settlement functions of system 844 and 846, including Interlink, into a single service for all products and services. Clearing continues to be performed separately by system 844 and system 846.

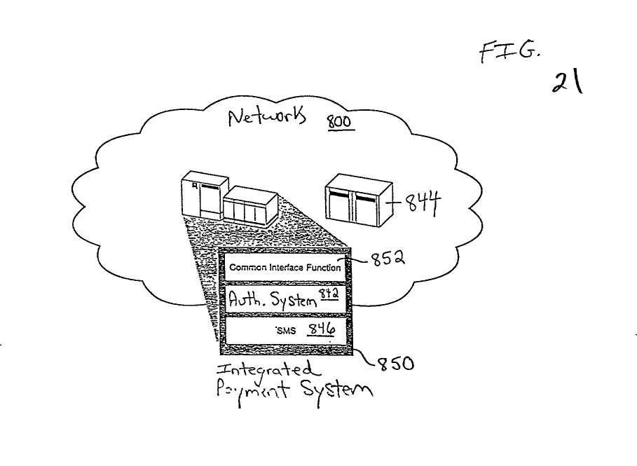

FIG. 21 illustrates another view of the components of telecommunications network 800. Integrated payment system 850 is the primary system for processing all online authorization and financial request transactions. System 850 reports both dual message and single message processing. In both cases, settlement occurs separately. The three main software components are the common interface function 852, authorization system 842 and single message system 846.

Common interface function 852 determines the processing required for each message received at an interchange center. It chooses the appropriate routing, based on the source of the message (system 842, 844 or 846), the type of processing request and the processing network. This component performs initial message editing, and, when necessary, parses the message and ensures that the content complies with basic message construction rules. Function 852 routes messages to their system 842 or system 846 destinations.

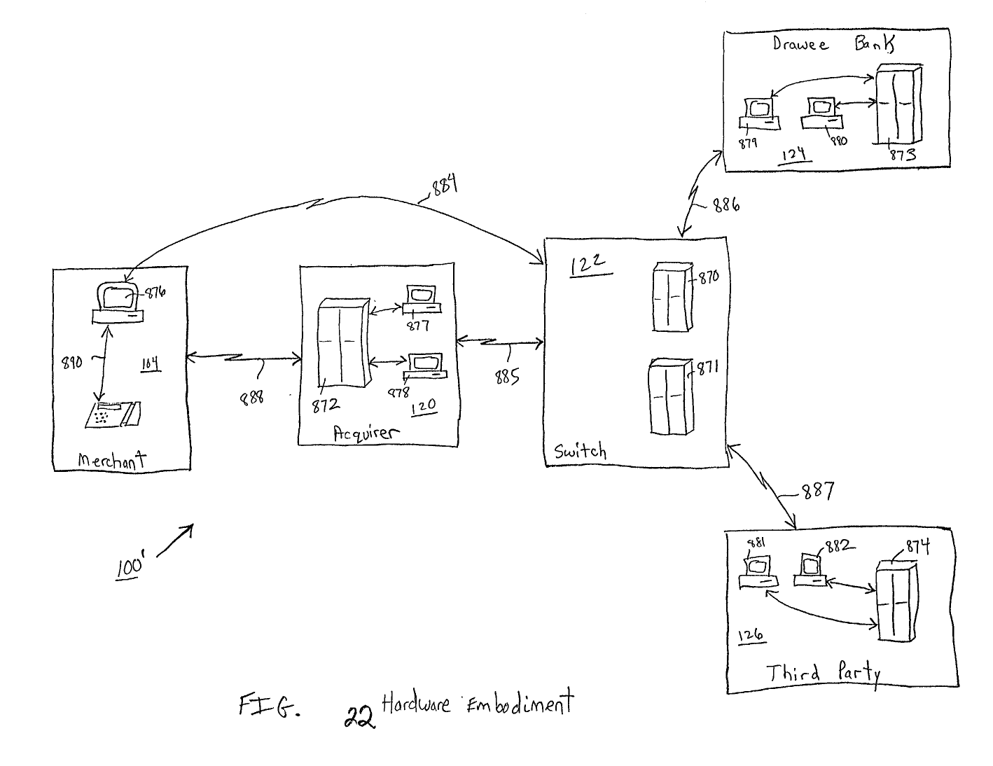

FIG. 22 illustrates in more detail a suitable hardware embodiment 100′ for the POS Check Service. Included within the switch, acquirer drawee bank and third party are mainframe computers 870-874 for performing processes. Access point computers 876-882 facilitate communication from an entity to switch 122. High bandwidth circuits 884-887 provide for online, real-time communication between the entities. Link 888 from the merchant to the acquirer is any suitable electronic transmission line such as a dial-up or leased telephone line. Data link 890, and in general, data links between access point computers and the host computer of an entity may use any suitable proprietary message format that the entity desires. As mentioned earlier, the format for messages between the switch and the access points use a suitable implementation of ISO 8583.

Merchant 104 may choose to communicate directly from its terminal using a proprietary message format over link 888 to its acquirer or may wish to install an access point 876 which then communicates to switch 122 using the protocol of the network. Mainframe 872 translates the message format used in link 888 into the network protocol for communication with the switch. Preferably, the mainframe within the switch, the access points and links 884-887 are all redundant so there is no single point of failure. In an alternative embodiment, merchant 104 may communicate with its acquirer over an Internet link. Additionally a direct exchange protocol using the Internet may also be used for communication among the various entities.

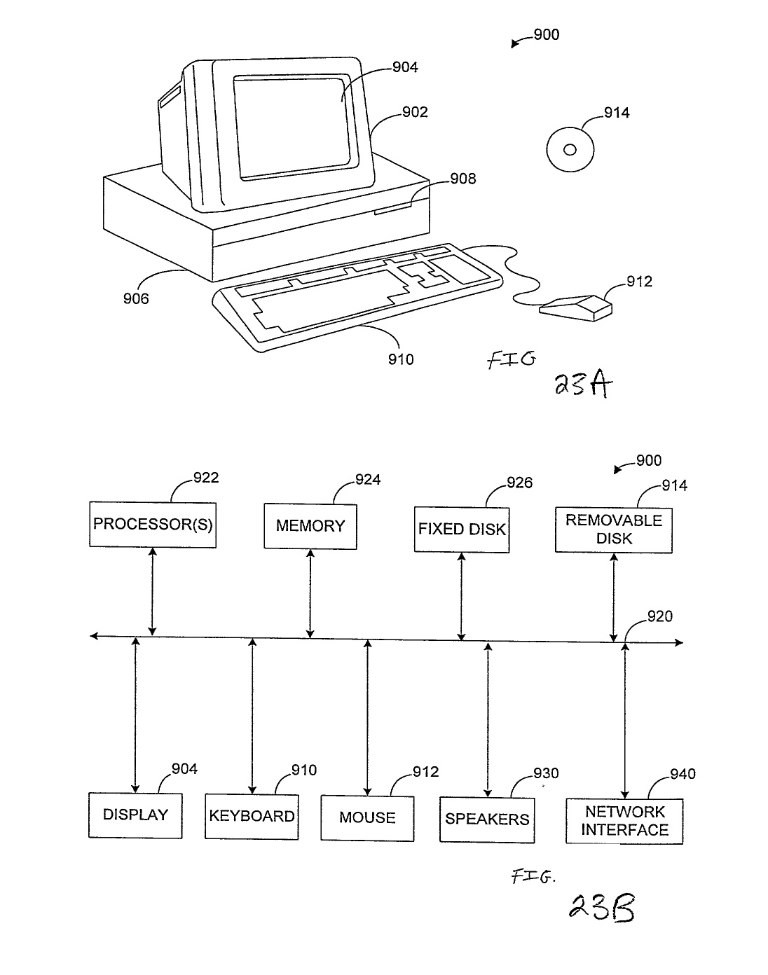

FIGS. 23A and 23B illustrate a computer system 900 suitable for implementing embodiments of the present invention. FIG. 23A shows one possible physical form of the computer system. Of course, the computer system may have many physical forms ranging from an integrated circuit, a printed circuit board and a small handheld device up to a huge super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 23B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Although the foregoing invention has been described in some detail for purposes of clarity of understanding, it will be apparent that certain changes and modifications may be practiced within the scope of the appended claims. For instance, the check and customer information may be entered at the point of sale using a scanner, OCR equipment, biometrics readers, keypads, voice recognition, etc., in lieu of a MICR device. Also, the account information may be represented on the check in many different forms and using different characters. Other services may be performed by a drawee bank or third party in addition to the three services described above. The telecommunications network used to perform online, real-time authorization may utilize any suitable hardware and software protocol. The Internet may be used to route transaction data, and wireless communication between entities is also contemplated. For example, a customer may use a wireless device to enter check information to have the transaction authorized at the customer's location. Therefore, the described embodiments should be taken as illustrative and not restrictive, and the invention should not be limited to the details given herein but should be defined by the following claims and their full scope of equivalents.

We claim:

1. A point-of-sale (POS) check service system comprising:
device means for receiving checking account information from a paper check of a customer, and for receiving an amount concerning a sale to said customer, said checking account information and said amount being collectively transaction information, said paper check not being used as a negotiable instrument and being returned to said customer;
a host computer arranged to receive said transaction information from said device means and to forward it into said POS check service system;
a switch computer arranged to receive said transaction information from said host computer and to further route said transaction information;
a drawee bank which receives said transaction information from said switch computer; and
a drawee computer of said drawee bank that receives said transaction information and is arranged to perform conversion, verification or guarantee based upon said transaction information, said drawee computer further arranged to return a response message to said host computer indicating the result of said conversion, verification or guarantee.

2. A POS check service system as recited in claim 1 further comprising:
a telecommunications network used for communications between said host computer, said switch computer and said drawee computer that provides online, real-time communications between said computers.

3. A POS check service system as recited in claim 1 wherein said device means includes a magnetic ink character recognition (MICR) device through which said paper check is swiped and a merchant point-of-sale terminal into which said amount may be entered.

4. A POS check service system as recited in claim 1 wherein said drawee computer is further arranged to perform conversion only, conversion with verification or conversion with guarantee based upon said transaction information.

5. A POS check service system as recited in claim 1 wherein said drawee computer is further arranged to receive said checking account information in the form of raw MICR data and to parse said checking account information to obtain a transit routing number and an account number of the customer, whereby parsing occurs reliably at a drawee bank and not at said device means.

6. A POS check service system as recited in claim 1 further comprising:
a service request message delivered to said switch computer which includes said transaction information and an indication of whether conversion only, conversion with verification or conversion with guarantee is desired.

7. A POS check service system as recited in claim 6 wherein said service request message includes a settlement code indicating how settlement will occur, thereby accommodating any customer bank and any type of service request.

8. A POS check service system as recited in claim 6 wherein said service request message includes a unique transaction identifier that ties together related transactions in a transaction set.

9. A point-of-transaction check service system comprising:
device means for receiving checking account information from a paper check of an individual and for receiving an amount representing a monetary transaction which is to be deposited into a depositing account, said checking account information, said amount and a depositing account being collectively transaction information, said paper check not being used as a negotiable instrument;
a host computer arranged to receive said transaction information from said device means and to forward it into said point-of-transaction check service system;
a switch computer arranged to receive said transaction information from said host computer and to further route said transaction information;
a drawee bank which receives said transaction information from said switch computer; and
a drawee computer of said drawee bank that receives said transaction information and is arranged to perform conversion, verification or guarantee based upon said transaction information, said drawee computer further arranged to return a response message to said host computer indicating the result of said conversion, verification or guarantee.

10. A point-of-transaction check service system as recited in claim 9 further comprising:
a financial institution holding said depositing account, to which said amount is deposited depending upon the result of said conversion, verification or guarantee.

11. A point-of-transaction check service system as recited in claim 9 further comprising:
a telecommunications network used for communications between said host computer, said switch computer and said drawee computer that provides online, real-time communications between said computers.

12. A point-of-transaction check service system as recited in claim 9 wherein said drawee computer is further arranged to perform conversion only, conversion with verification or conversion with guarantee based upon said transaction information.

13. A point-of-transaction check service system as recited in claim 9 wherein said drawee computer is further arranged to receive said checking account information unparsed and to parse said checking account information to obtain a transit routing number and an account number of the customer, whereby parsing occurs reliably at a drawee bank and not at said device means.

14. A point-of-transaction check service system as recited in claim 9 further comprising:
a service request message delivered to said switch computer which includes said transaction information and an indication of whether conversion only, conversion with verification or conversion with guarantee is desired.

15. A point-of-transaction check service system as recited in claim 14 wherein said service request message includes a settlement code indicating how settlement will occur, thereby accommodating any customer bank and any type of service request.

16. A point-of-transaction check service system as recited in claim 14 wherein said service request message includes a unique transaction identifier that ties together related transactions in a transaction set.

17. A method of performing a transaction at a point of sale, said method comprising:
a step for performing the function of receiving checking account information from a paper check of a customer;
entering an amount of said transaction into a terminal;
assembling a service request message that includes said checking account information, said amount and a request to perform conversion only, conversion with verification or conversion with guarantee;
sending said service request message to a switch computer arranged to receive and to further route said service request message;
receiving a response message via said switch computer indicating a response to said request to perform conversion only, conversion with verification or conversion with guarantee; and
returning said paper check to said customer, said paper check not being used as a negotiable instrument.

18. A method as recited in claim 17 wherein said step for performing the function of receiving includes:
swiping a paper check of a customer through a device to obtain raw magnetic ink character recognition (MICR) information from said check.

19. A method as recited in claim 17 further comprising:
performing said steps of sending and receiving over a telecommunications network that provides online, real-time communications, whereby said customer at said point of sale waits a reasonable time for said response message.

20. A method of processing a paper check transaction occurring at a point of sale, a monetary amount originating at said point of sale and said paper check providing checking account information, said method comprising:
receiving a service request message from said point of sale, said service request message including said checking account information, said monetary amount and a request for a type of check service;
determining whether a portion of said checking account information matches with one of a plurality of participating banks;
determining whether said request for a type of check service matches with a service provided by one of said banks;
determining where to route said service request message;
sending said service request message to an authorizing institution that is equipped to handle said request for a type of check service;
receiving a response message to said service request message from said authorizing institution; and
sending said response message to said point of sale indicating the result of said request for a type of check service, whereby said paper check is not used as a negotiable instrument and is returned to said customer.

21. A method as recited in claim 20 further comprising:
performing said steps of receiving and sending over a telecommunications network that provides online, real-time communications, whereby said customer at said point of sale waits a reasonable time for said response message.

22. A method as recited in claim 20 wherein said request for a type of check service includes a request for conversion only, conversion with verification or conversion with guarantee.

23. A method as recited in claim 20 wherein said checking account information is received in raw MICR data format and is sent to said authorizing institution in order to parse said checking account information to obtain a transit routing number and an account number of the customer, whereby parsing occurs reliably at an authorizing institution and not at said point of sale.

24. A method as recited in claim 20 further comprising:
adding a settlement code indicating how settlement will occur to said service request message, thereby accommodating any customer bank and any type of service request.

25. A method as recited in claim 20 further comprising:
adding a unique transaction identifier to said service request message, thereby tying together related transactions in a transaction set.
